(19) United States
(12) Patent Application Publication
(10) Pub. No.: US 2024/0033044 A1
(43) Pub. Date: Feb. 1, 2024

(54) ORTHODONTIC TREATMENT INCLUDING WIRE-DRIVEN AND ALIGNER PHASES

(71) Applicant: 3M INNOVATIVE PROPERTIES COMPANY, St. Paul, MN (US)

(72) Inventors: Ralf M. Paehl, Melle (DE); David K. Cinader, JR., Woodbury, MN (US); Dietmar Blees, Loehne (DE); Ralf Schlimper, Melle (DE); Ming-Lai Lai, Afton, MN (US); Richard E. Raby, Lino Lakes, MN (US)

(21) Appl. No.: 18/039,834

(22) PCT Filed: Dec. 16, 2021
(86) PCT No.: PCT/IB2021/061860

§ 371 Date: Jun. 1, 2023

Related U.S. Application Data
(60) Provisional application No. 63/132,854, filed on Dec. 31, 2020.

(51) Int. Cl. A61C 7/08; A61C 7/16; A61C 7/20

(52) U.S. Cl. CPC A61C 7/08; A61C 7/16; A61C 7/20

(57) ABSTRACT

A method includes wire driven phase in which a plurality of attachments are bonded to teeth, the attachments including a wire-retaining region and an engagement region. The engagement region has a shoulder configured to releasably engage a corresponding indentation in an aligner tray. An archwire is inserted in to the wire-retaining regions to move a first malaccluded tooth from a first position to a second position. An aligner phase follows the wire driven phase, in which the archwire is removed, and an aligner tray is applied over the teeth of the patient. The aligner tray includes cavities shaped to receive and resiliently position the first maloccluded tooth from the second position to a third position, and further includes indentations configured to releasably engage at least a portion of the engagement regions on the attachments.

### BACKGROUND

Traditional fixed orthodontic appliances utilize brackets affixed to the teeth of a patient, and wires engaged by slots in the brackets exert force on the teeth to move at least one tooth from a first maloccluded position into a desired finished position. In the initial phases of a treatment, where a significant amount of tooth movement can be required, the amount and direction of the force applied to the teeth can be set by positioning the brackets on the labial or lingual surfaces of the teeth and inserting superelastic wires into the slots in the brackets to deliver relatively continuous movement forces.

While brackets and wires are very effective to provide a wide variety of tooth movements, for aesthetic reasons patients often prefer aligner trays that can be placed over the teeth. The aligner trays can be made of clear materials that are less visible during treatment, and the trays can be inserted in or removed from the mouth when desired. The aligner trays utilize the resilient properties of the polymeric material and the precisely shaped tooth-retaining cavities to reposition teeth, and each aligner tray in a series of aligner trays can be used to gradually move the teeth relatively small distances compared to the movements possible with brackets and wires. Aligner trays are also limited mechanically to certain tooth movements, and as such do not have the versatility of brackets and wires, particularly in the early stages of treatment where larger ranges of tooth movement may be required. For the first phase of an orthodontic treatment, a larger number of aligner stages may be necessary to resolve the worst malocclusions. Smaller tooth movements per stage, and more precisely defined tooth repositioning make aligner trays particularly well suited for finishing the final phases of an orthodontic treatment.

### SUMMARY

In general, the present disclosure is directed to an orthodontic treatment system and method that utilizes an initial wire-driven treatment phase in which attachments are affixed to the teeth. The attachments include a bonding portion bonded to a labial or a lingual surface of a tooth, as well as a wire-retaining region configured to retain an archwire such as a resilient wire to provide larger and more complex tooth movements that may be required to efficiently complete an initial treatment phase in which teeth are moved from an initial position to a second position. The initial treatment phase is followed by a subsequent or final aligner treatment phase in which the archwire is removed from the attachments and a series of aligner trays are applied over the teeth to move at least one tooth from the second position to a third position. The aligner trays include a plurality of cavities precisely shaped to receive and resiliently position teeth, and further incorporate an arrangement of indentations or notches configured to releasably engage an engagement region on an exposed surface of the attachments. In some cases, the smaller tooth movements and more precisely defined tooth repositioning make aligner trays particularly well suited for finishing the final phases of an orthodontic treatment. In some embodiments, the attachments may optionally be re-used for an additional wire-driven phase following the aligner phase, or may be removed from the teeth so that a second set of aligner trays can be employed to fine-tune or maintain the alignment of one or more teeth.

The system and method of the present disclosure utilizes two different tooth alignment tools with different capabilities and strengths, which can potentially provide faster and more aesthetic orthodontic treatments. The same attachments bonded to the teeth are used for both the wire-driven phase and the aligner phases of the treatment. In the wire-driven phase the attachments receive the resilient wires, and in the aligner phase the attachments engage the aligner trays to facilitate a wider range of tooth movements than possible with aligner trays alone.

In one aspect, the present disclosure is directed to a method for repositioning a first maloccluded tooth of a patient. The method includes a wire driven phase, including: providing a plurality of attachments, each attachment having a wire-retaining region and an engagement region, wherein the engagement region has a shoulder configured to releasably engage a corresponding indentation in an aligner tray; bonding each attachment in the plurality of attachments to a tooth of the patient; and inserting an archwire in to the wire-retaining regions in the attachments to move the first malaccluded tooth from a first position to a second position different from the first position. An aligner phase follows the wire driven phase, the aligner phase including: removing the archwire from the wire-retaining regions in the plurality of attachments, and applying an aligner tray over the teeth of the patient, wherein the aligner tray includes a plurality of cavities shaped to receive and resiliently position the first maloccluded tooth from the second position to a third position different from the second position. The aligner tray further includes an arrangement of indentations configured to releasably engage at least a portion of the engagement regions on the attachments.

In another aspect, the present disclosure is directed to an orthodontic treatment system, including: a plurality of attachments, each attachment including a body with a first end having bonding portion configured to be bonded to a surface of a tooth of a patient; and a second end opposite the first end, wherein the second end includes a catch configured to retain an archwire, and wherein an external surface of the catch has an engagement region with a shoulder; a plurality of archwires insertable into the wire retaining hooks in the attachments; and at least one aligner tray, each aligner tray including a plurality of cavities shaped to receive and resiliently position at least one tooth of the patient, the aligner tray further including at least one indentation configured to releasably engage with the shoulder in the engagement region of at least one attachment in the plurality of attachments.

In another aspect, the present disclosure is directed to an orthodontic treatment system, including: a computer with instructions that, when executed, cause the computer to receive an initial position of at least one tooth of a patient in a treatment plan, receive a final position of the at least one tooth in the treatment plan, and determine a movement geometry including movement of the at least one tooth between the initial position and the final position, the treatment plan including; a wire-driven phase, including: bonding a plurality of attachments to at least a first portion of the teeth of the patient, each attachment in the plurality of attachments including a body with a first end having a bonding portion configured to be bonded to a surface of a tooth; and a second end opposite the first end, wherein the second end includes a wire-retaining region and an engagement region with a shoulder and an undercut region configured to releasably engage a corresponding indentation in an aligner tray; inserting an archwire into the wire-retaining regions in the attachments to move at least one tooth in the first portion of teeth from the initial position to a second position different from the initial position; and an aligner phase following the wire driven phase, the aligner phase including: removing the archwire from the wire-retaining regions in the plurality of attachments, and applying an aligner tray over at least a portion of the teeth of the patient, wherein the aligner tray includes a plurality of cavities shaped to receive and resiliently position at least one tooth in the first portion of teeth of the patient according to the treatment plan from the second position to a third position different from the second position, the aligner tray further including an arrangement of indentations configured to releasably engage at least a portion of the shoulders and undercut regions in the engagement regions of the attachments.

In another aspect, the present disclosure is directed to an attachment device for an orthodontic treatment, the device including: a body having: a first end including a bonding portion configured to be bonded to a surface of a tooth; and a second end opposite the first end, wherein the second end includes a wire-retaining groove and an external surface including an engagement region, wherein the engagement region has a shoulder configured to releasably engage a corresponding indentation in an aligner tray.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1A is schematic perspective view of an embodiment of an attachment bonded to a surface of a tooth according to the present disclosure.

FIG. 1B is schematic perspective view of overhead view of another embodiment of an attachment bonded to a surface of a tooth.

FIG. 2A is a schematic cross-sectional view of an embodiment of an orthodontic system including an attachment bonded to a surface of a tooth and an aligner tray over the tooth and releasably attached to the attachment.

FIG. 2B is a schematic cross-sectional view of another embodiment of an orthodontic system including an attachment bonded to a surface of a tooth and an aligner tray over the tooth and releasably attached to the attachment.

FIG. 3 is a flow chart of a method for orthodontic treatment according to the present disclosure.

FIGS. 4A and 4B are schematic perspective views of an orthodontic system including attachments and an archwire configured for vertical movement of a tooth.

FIG. 5A is a schematic perspective view of an orthodontic system including attachments and an archwire configured for horizontal movement of a tooth.

FIG. 5B is a schematic perspective view of attachments with wire-retaining regions configured for applying forces to teeth in various directions.

FIG. 5C is a flow chart of an embodiment of a process for selecting attachments suitable for a wire-driven phase of an orthodontic treatment.

FIG. 6 is a schematic perspective view showing engagement of the attachments of FIG. 5B with an indentation in a portion of an aligner tray.

FIG. 7 is a schematic perspective view of an embodiment of an orthodontic system including attachments and an archwire configured for angulation of a tooth.

FIG. 8A is a schematic overhead view, and FIG. 8B is a schematic perspective view, of an orthodontic system including attachments and an archwire configured to rotate a tooth.

FIG. 9A is a schematic perspective view of an embodiment of an orthodontic system including basic attachments and an archwire.

FIGS. 9B-9C are side views of attachments of the orthodontic system of FIG. 9A.

FIG. 10A is a schematic perspective view of attachments of the present disclosure bonded to the lingual surface of teeth.

FIG. 10B is a schematic perspective view of the attachments of FIG. 10A showing the direction of force applied to the teeth by the attachments of FIG. 10A.

Like symbols in the drawings indicate like elements.

### DETAILED DESCRIPTION

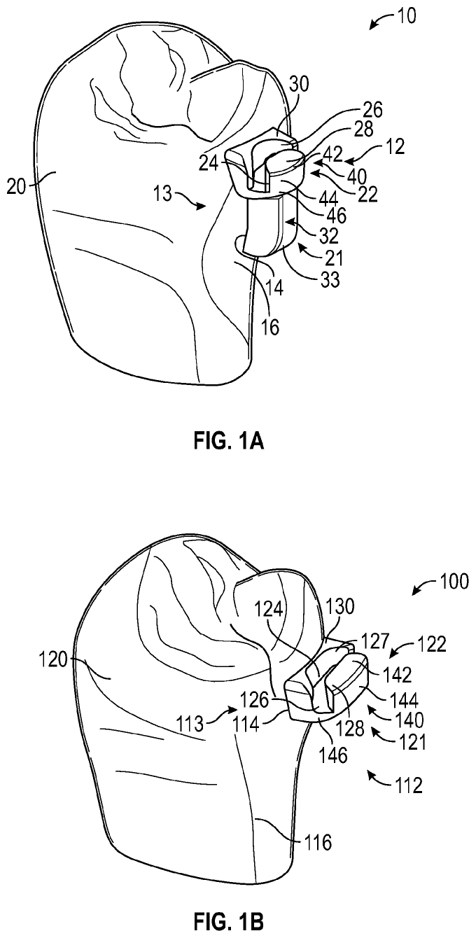

Referring now to FIG. 1A, a schematic illustration (which is not to scale) of an attachment article 10 includes a body 12 with a first end 13 having a bonding portion 14. The bonding portion 14 is shaped to conform to and bond with an exposed labial or lingual surface 16 of a tooth 20. In various embodiments, the bonding portion 14 may include a bonding area shaped, contoured, or otherwise configured for attachment to a particular surface 16 or portion thereof.

The body 12 further includes a second end 21 with a groove 26 having an internal surface 24 configured to retain an archwire (not shown in FIG. 1A). The groove 26 has a cross-sectional shape configured to retain a selected archwire, and typical cross-sectional shapes include, but are not limited to, round, square, rectangular, arcuate (for example, C-shaped or U-shaped), and the like, or may include combinations of linear and arcuate elements (for example, a J-shape, a D-shape, or a V-shape).

In some embodiments, the body 12 includes a catch 22 that can be used to securely retain an archwire in the groove 26, and in some embodiments the catch 22 may be deflected to allow insertion or removal of the archwire from the groove 26. The catch 22 includes an optional flap-like retaining region 28 that extends toward the first end 13 of the body 12 and at least partially overlies the groove 26 to further enhance retention of the archwire in the groove 26.

In some embodiments, the body 12 of the attachment article 10 further includes an optional spacer portion 30 extending away from the bonding portion 14 and shaped to extend the groove 26 a predetermined distance from the tooth surface 16. In some embodiments, the shape and dimensions of the spacer portion 30 are configured to enable wire insertion and maintain retention of the archwire after the archwire is inserted into the groove 26. However, in some cases, as shown in more detail below, the body 12 can be designed with a minimal spacer portion 30, or even no spacer portion 30, so that the archwire can reside closer to or against the surface 16 of the tooth 20. In addition, in some examples the body 12 can include a support region 32 underlying catch 22 and the groove 26, wherein the support region 32 has an external surface configured to rest against or engage an aligner tray (not shown in FIG. 1A). In some embodiments, the inclination of the support region 32 may be configured to make the aligner tray easier to remove.

The catch 22 of the attachment article 10 includes an exposed external engagement surface 40 distal the tooth surface 16 and the bonding portion 14 configured to releasably engage an appropriately shaped indentation in an aligner tray (not shown in FIG. 1A). The shapes of the corresponding indentation in the aligner tray may vary widely, and in various example embodiments can include slots, apertures, protrusions, bubbles, envelopes, an annulus, wedges, prisms, or combinations thereof. The shape of the engagement surface 40 may vary widely to fit into the indentation or arrangement of indentations in the aligner tray, but in the embodiment of FIG. 1A includes a rounded shoulder 42, a planar portion 44 that is generally parallel to the bonding portion 14, and an undercut region 46. In some examples, as noted above, the support region 32 may also include an engagement surface 33 to further retain the alignment tray.

In various embodiments, the attachment article 10 is made from a metal, a ceramic, a polymeric material, and the like. In some examples, all or a portion of the article 10 may be directly three-dimensionally (3D) printed using SLM, SLA or DLP vat printing or precision binder jetting from a polymeric material, a polymeric-metal composite, or a polymeric-ceramic composite, or 3 or 5 axis milled from any of these materials. In some embodiments, the polymeric material, metal, ceramic, or composite thereof has relatively elastic properties so that the catch 22 can bend and flex to facilitate introduction of the archwire and move back into place once the archwire is seated in the groove 26. However, the material used to form the attachment article 10 does not require elasticity, and the flexibility of the archwire itself may be sufficient to allow insertion and retention or self-ligation.

The bonding portion 14 of the attachment article 10 may have any suitable shape and size depending on the intended application of the attachment article 10, and may be made larger or smaller as necessary to facilitate secure attachment to the surface 16 of the tooth 20. The attachment article 10 may be bonded to the surface 16 of the tooth 20 using any suitable orthodontic adhesive, and examples include, but are not limited to epoxy, (meth)acylate-based adhesives, and the like, wherein (meth)acrylate includes acrylates and methacrylates. In some examples, the body 12 of the attachment article may include a limited selection of basic, mass-produced standardized designs, and the bonding portion 14 may be individually configured to fit a particular tooth by a process such as, for example milling, laser machining, 3D printing, and the like, directly onto the standardized body 12.

Referring now to FIG. 1B, in another embodiment an attachment article 100 includes a body 112 with a first end 113 having a bonding portion 114 bonded to a surface 116 of a tooth 120. The body 112 includes a spacer portion 130 extending away from the tooth surface 116. The body 112 further includes a second end 121 with a catch 122. The catch 122 includes an internal surface 124 forming a groove 126 configured to retain an archwire (not shown in FIG. 1B). The groove 126 has a cross-sectional shape configured to retain an archwire with a corresponding cross-sectional shape, and in the embodiment of FIG. 1B includes a recessed region 127 configured to ease introduction or removal of the archwire. The catch 122 includes an overhanging retaining region 128 that extends toward the first end 113 of the body 112 and partially overlies the groove 126.

The catch 122 includes an exposed external engagement surface 140 distal of the tooth surface 116 and the bonding portion 114. The engagement surface 140 is configured such that at least a portion of the engagement surface 140 releasably engages an appropriately shaped indentation in a polymeric aligner tray (not shown in FIG. 1B). In the embodiment of FIG. 1A, the engagement surface 140 includes a rounded shoulder 142, a planar portion 144 generally parallel to the bonding portion 114 and the tooth surface 116, and an undercut region 146.

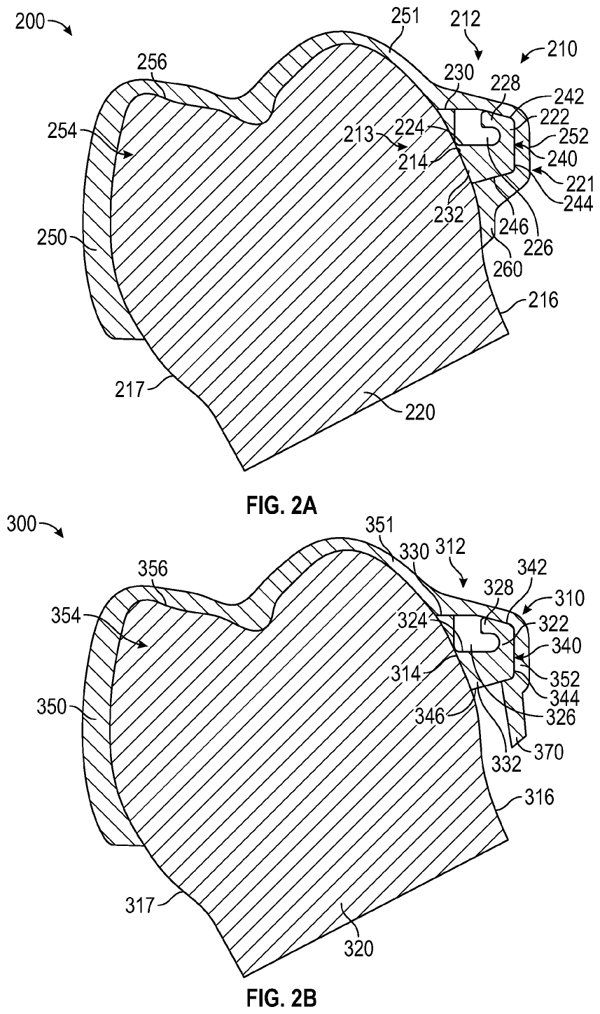

Referring now to the construction 200 in FIG. 2A, an attachment article 210 includes a body 212 with a first end 213 having a bonding portion 214 bonded to a surface 216 of a tooth 220. The body 212 further includes a second end 221 with a catch 222. The catch 222 includes an internal surface 224 forming a generally J-shaped groove 226 configured to engage and retain an appropriately shaped archwire (not shown in FIG. 2A). The catch 222 includes a retaining region 228 that extends toward the first end 213 of the body 212 and at least partially overlies the groove 226 to further enhance retention of the archwire in the groove 226. The body 212 includes a minimal spacer portion 230 and a support region 232 underlying the catch 222.

An aligner tray 250 includes a cavity 254 shaped to fit over a crown 256 of the tooth 220 and engage the opposed surfaces 216, 217 of the tooth 220. The aligner tray further includes a wall 251 including an indentation (i.e., receptacle) 252 shaped to extend away from the surface 216 of the tooth 220 and releasably engage at least a portion of an exposed external engagement surface 240 of the attachment article 210.

In various embodiments, the aligner tray 250 may be made from a wide variety of materials including metals, ceramics, polymers, and mixtures and combinations thereof. The aligner tray 250 may be formed using a wide variety of techniques including, but not limited to, molding, 3D printing, thermoforming, laser patterning, microreplication, and the like. Suitable materials and methods for making aligner trays are explored, for example, in co-owned U.S. Application 63/091,113, filed Oct. 13, 2020.

In one embodiment, a suitable configuration of tooth (or teeth)-retaining cavities are formed in a substantially flat sheet of a single layer of a polymeric film, or a multilayered polymeric film that includes multiple layers of polymeric material. In some embodiments, the polymeric film may be formed in a dispersion and cast into a film, or applied on a mold with tooth-receiving cavities. In some embodiments, the polymeric film may be prepared by extrusion of polymeric layer materials through an appropriate die to form the film. In some embodiments, a reactive extrusion process may be used in which one or more polymeric reaction products are loaded into the extruder to form one or more layers during the extrusion procedure. In yet other embodiments, the polymeric film may be deposited onto a mold via chemical vapor deposition, as described in U.S. Provisional Application No. 62/736,774, filed Sep. 26, 2019, and entitled “Parylene Dental Articles.”.

In some embodiments, the polymeric film may later be thermoformed into a dental appliance with tooth-retaining cavities, injected into a mold including tooth-retaining cavities, or produced using a three-dimensional (3D) printing process. The tooth-retaining cavities may be formed by any suitable technique, including thermoforming, laser processing, chemical or physical etching, and combinations thereof, but thermoforming has been found to provide good results and excellent efficiency. In some embodiments, the polymeric film is heated prior to forming the tooth-retaining cavities, or a surface thereof may optionally be chemically treated such as, for example, by etching, or mechanically embossed by contacting the surface with a tool, prior to or after forming the cavities.

The polymeric film, the formed dental appliance, or both, may optionally be crosslinked with radiation chosen from electron beam, gamma, UV, and mixtures and combinations thereof.

At least a portion of the engagement surface 240 on the attachment article 210 is configured to releasably engage the indentation 252, and includes a rounded shoulder 242, a planar portion 244 that is generally parallel to the bonding portion 214, and an undercut region 246. In the embodiment of FIG. 2A, the wall 251 of the polymeric aligner tray 250 further includes an undercut region 260 shaped to extend around the engagement surface 240 and fit against the surface 216 of the tooth 220 in a region beneath the attachment article 210.

In another embodiment shown in FIG. 2B, a construction 300 includes an attachment article 310 with a body 312 attached to a surface 316 of a tooth 320 via a bonding portion 314. The body 312 further includes a catch 322 with an internal surface 324 forming a generally J-shaped groove 326 configured to retain an archwire (not shown in FIG. 2B). The catch 322 includes a retaining region 328 that partially overlies the groove 326. The body 312 further includes a spacer portion 330 and a support region 332 underlying the catch 322.

A polymeric aligner tray 350 includes a cavity 354 shaped to fit over a crown 356 of the tooth 320 and engage the opposed surfaces 316, 317 of the tooth 320. The polymeric aligner tray further includes a wall 351 including a protruding indentation 352 shaped to releasably engage an exposed external engagement surface 340 of the attachment article 310.

At least a portion of the engagement surface 340 is configured to releasably engage the indentation 352, and includes a rounded shoulder 342, a planar portion 344 generally parallel to the bonding portion 314, and an undercut region 346. In the embodiment of FIG. 2B, the wall 351 of the polymeric aligner tray 350 has a reduced undercut region compared to the embodiment of FIG. 2A, which is shaped to fit around the engagement surface 340 and engage the surface 316 of the tooth 320 in a region beneath the attachment article 310, and extends only part of the distance between an occlusal portion of the tooth and the gingival line (not shown in FIG. 2B). Instead, the polymeric aligner tray 350 includes a tab 370 extending downward from the indentation 352 that does not contact the tooth surface 316. In some orthodontic treatments, the indentation 352 including the tab 370 may fit less snugly around the engagement surface 340 of the attachment device 310, and provide a path that makes attachment and removal of the polymeric aligner tray 350 easier and more comfortable for the patient. In another example embodiment, to avoid potential tongue irritation, the tab 370 may be configured to angle or lean toward the tooth surface 316. In yet another embodiment, tab 370 may be simply omitted, leaving a small ledge of tray material projecting at least somewhat horizontally into the undercut region.

The attachment devices and polymeric aligner trays shown in FIGS. 1A-1B and 2A-2B are particularly well suited for use in an orthodontic method for repositioning at least one tooth of a patient using multiple types of orthodontic appliances. The method includes an wire driven phase in which the attachments are bonded to at least one of the lingual and labial surfaces of the teeth. A resilient archwire is inserted into the wire-retaining grooves in the attachments to move at least one tooth in a first portion of the teeth from a first position to a second position different from the first position.

The method further includes an aligner phase, which in various embodiments may be implemented prior to or after the wire driven phase. In the aligner phase the archwire not present in the wire retaining regions of the attachments, and an aligner tray is utilized to further reposition teeth of the patient. The aligner tray includes a plurality of cavities shaped to receive and resiliently position at least one tooth in the first portion of teeth of the patient from the second position to a third position different from the second position. The aligner tray further includes an arrangement of indentations configured to releasably engage at least a portion of the engagement regions on the attachments.

In some embodiments, the method further includes a second wire-driven phase following the aligner phase. The second wire-driven phase utilizes the attachments that are bonded to the teeth, and may utilize the same or a different archwire to efficiently move the teeth from the third position to a fourth position.

In some embodiments, the attachments may be removed following the aligner phase, and an aligner tray may be used without the attachments to move the teeth from the third position to a fourth position and provide a finer finishing adjustment to the teeth.

In some embodiments, the method includes an initial aligner phase followed by a wire-driven phase. The subsequent wire-driven phase can be followed by one or more aligner or wire-driven phases.

Dividing the course of orthodontic treatment into at least two distinct phases can have a number of advantages. In particular, crowded cases suffer from interproximal interferences between the teeth which can impede tooth movements. For aligner trays to be effective, accurate 3D scan data should be used to create realistic models of the teeth. The most difficult regions of the teeth to model accurately are the interproximals, which are coincidentally the regions where interferences are most likely to occur. Intraoral scanners can have difficulty imaging these areas, and physical impression material can fail to penetrate the thinnest regions between the teeth. Triangular meshing software can fail to properly identify surfaces in the interproximals due to points in neighboring teeth being confused with points in the tooth of interest. Interproximal mesh data may be removed and regenerated according to parametric models in subsequent processing steps. Interproximal data used to predict where teeth should intersect during staged tooth movements may be slightly erroneous, and thus the prescribed movements may be mechanically impeded, if not impossible, due to tooth collisions resulting in excessive friction or blockage. Because polymeric aligner trays prescribe very definite tooth movements, leaving no degrees of freedom undefined, when teeth collide, reaction forces that might otherwise cause a tooth to change direction and deviate from its prescribed path are constrained by aligner material fully surrounding the teeth.

In contrast, attachments and archwires provide for at least one degree of freedom that remains undefined: mesio-distal movement as the result of sliding mechanics, as well as “slop” between wire and bracket and the wire deflection, particularly when highly flexible wires are used. Because an archwire is able to slide along a channel in the attachment, i.e. the attachment slot, the tooth is free to move mesio-distally if a force is applied in any other direction that contains a significant mesio-distal vector component. For example, a 45° diagonal force vector on a tooth might decompose into a labial vector component and a distal vector component, each having approximately equal magnitude. If the tooth is positioned somewhat to the lingual side of its mesial neighbor, it may be blocked on its mesial edge from moving labially by the interfering tooth, but provided there is no contact with a distal neighbor, it may be free to slide along the archwire in a distal direction until the interference with its mesial neighbor is resolved. Once this occurs, the tooth may be free to express movement in the labial direction according to the labial vector component of the force vector. Such freedom is not possible with a conventional aligner tray due to the tray surrounding the teeth on all sides.

By treating with attachments & archwires in an initial phase of treatment, sliding mechanics can be exploited to resolve collisions between teeth in the interproximal regions automatically, without having to prescribe their movements exactly. This can be faster than treating with aligner trays alone because the applied forces from the archwires are relatively continuous, and the movements are less impeded by virtue of allowing more degrees of freedom.

One advantage of fixed orthodontic appliances used in the wire driven phase is that the risk of patient non-compliance is reduced, as the patient is not able to take out the appliance during the treatment. The amount of control needed to accomplish the initial tooth movements in the wire driven phase can be set by adjusting the slot wire system. For example, attachments placed on all or a portion of the teeth can be impacted by the elastic properties of the archwires. For example, in some embodiments archwires with a rectangular cross-sectional shape and corresponding rectangular wire retaining regions in the attachments on the teeth provide the greatest degree of control. In some cases, particularly when nickel titanium and copper nickel titanium wires are used, the archwires can deliver relatively continuous forces, which are very helpful to move teeth in the initial stages of a treatment, where often a lot of travel is needed. In contrast, force exerted by an aligner tray may decrease more rapidly once a tooth has begun to move. As such, wires tend to have a longer range of expression compared to aligner trays.

A typical malocclusion that benefits from a wire driven phase is crowded front teeth, which can take a long time to be resolved by an aligner, but for the reasons outlined above has a rapid progression when being treated with attachments and archwires. Because the aligner tray is pushing on a crown of a tooth, which is embedded in the jawbone, aligner trays tend to tip the crowns of the teeth into a space, rather than keeping them upright, and in some examples an attachment and wire system is better able to move the crowns without this undesired side effect.

A wire provides a track along which the bracket can slide, and the driving force is typically an elastomeric chain connecting the brackets and pulling them together, so the engagement between the bracket slot and the archwire provides limited opportunity for the crowns of the teeth to tip into the space. In another example, resolving curve of Spee by extruding bicuspids may be more efficient with an attachment and wire system due to the difficulty in grasping the teeth with the cavities in the aligner tray. Rotating round teeth like bicuspids and cuspids can also be troublesome with aligners, and may benefit from an attachment and wire approach.

In some embodiments, if custom-bent (or otherwise custom fabricated) archwires are used in the first wire driven phase of treatment, there is an opportunity to place the bonded appliances (attachments) more strategically, not just in positions that would be convenient for achieving the movements of the wire-driven phase, but also with consideration given to tray engagement mechanics and the movements prescribed in other phases of treatment using aligner trays. For example, the most convenient appliance bonding site on the tooth for attachment and wire phase might be the facial axis point (FA Point), but to improve engagement of a clear aligner to the tooth in the aligner phase, given the prescribed tooth movement, the lack of features in the natural dental anatomy, and the coupling points on the tooth, the appliance might be better placed 1-2 mm gingival of the FA Point. In such a case, if modifying the position of the appliance presents no deleterious effects, then the compromised position might be used for the wire driven phase, and a custom archwire can be fabricated that is designed to engage the appliance at this other position. The appliance would then be better positioned for the aligner phase when the archwire is removed and a clear aligner is installed on the teeth.

In some examples, the attachments can also be placed on the lingual surface of the teeth, which can make the wire-driven phase more aesthetic for the patient. However, in other examples the attachments are on the labial surface of the teeth are and thus visible. For this reason, patients tend to prefer aligner trays for reasons of aesthetics and easier dental hygiene, there is a motivation to switch to aligners as soon as the difficult tooth movements, which are likely to be impeded by collisions, have been achieved. Aligners are considered less painful and a more lifestyle type of appliance, as the aligners are barely visible and allow the patient to decide for themselves when or when not to have them in the mouth. Aligner trays can provide little tooth movement per stage only, and can be limited mechanically to certain tooth movements. Smaller tooth movements per stage and precisely defined tooth positions and orientations are good preconditions for excellent finishing capabilities. In some embodiments, the aligner trays can be used for smaller, finishing movements of the teeth after the larger tooth movements are complete from the wire driven phase.

The orthodontic treatment methods of the present disclosure provide two appliance types as two different tools with different capabilities and strengths, and offer the potential for faster and more aesthetic patient treatments. It is desirable if the same appliances which were used to move teeth in the first phase of treatment using attachments and wires can also be used to aid movement of the teeth in the second phase of treatment by providing improved engagement of the aligner tray with the teeth.

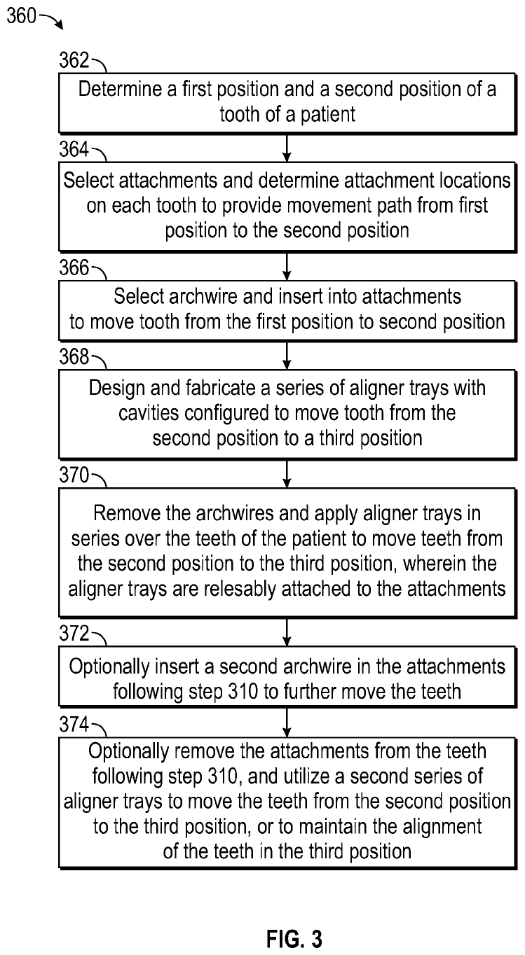

FIG. 3 is a flowchart illustrating steps of a method 360, such as a computer-implemented method, for providing a sequential wire driven treatment phase and aligner phase. In step 362, the method includes determining first and second positions of a tooth, which as noted above may be determined by an appropriate imaging technique such as three-dimensional scanning, CT scanning, and the like. Thereafter, in step 364 the types of attachments on each tooth, and the attachment locations on each tooth, are determined either manually or digitally to provide the movement path from the first position to the second position. In step 366, one or a series of archwires is selected and inserted in the attachments to move the teeth from the first position to the second position.

In step 368, after larger tooth movements are substantially complete or completed in step 366, a series of aligner trays is digitally designed and fabricated including one or more cavities configured with a volume or geometry to accommodate smaller or finishing movements of the attachment bonded teeth from the second position to a third position. In step 370, the archwire is removed from the attachments and each of the alignment trays in the series are applied over the teeth of the patient to gradually move the teeth from the second position to the third position.

In step 372, following the aligner phase set forth in steps 368-370, in an optional additional phase a second archwire, which may be the same or different from the first archwire, is inserted into the attachments for further tooth movement. In some examples, the wire-driven phase including the second archwire may be followed by an optional alignment tray or further series of aligner trays with cavities configured to move the teeth from the second position to the third position.

In step 374, in another optional phase following the aligner phase in steps 368-370, the attachments are removed from the teeth and a second series of aligner trays is designed with cavities configured to move the teeth from the second position to the third position, or to maintain the alignment of the teeth in the third position.

In some examples, the dental treatment system according to the present disclosure is provided to a dental practitioner in the form a kit including a series of attachments with different shapes configured to provide different types of tooth movements (more details are provided below), archwires and orthodontic aligner trays, as well as instructions for patient use. Suitable additional items for the kit, which are not intended to be limiting, include, one or more of a carrying case, a removal tool to help a patient remove the aligner from the teeth, a seating tool to assist forcing the aligners onto the teeth, a tooth brush, aligner tray cleaning tablets, powder/crystals, or gel/foam/liquid, abrasive papers or objects for addressing discomfort from sharp edges or corners on the dental appliance, a whitening gel or pen, dental floss, a dental pick, wax, and the like.

A wide variety of different attachment designs may be used to achieve specific tooth movements in the methods above, and some examples, which are not intended to be limiting, are shown and discussed below.

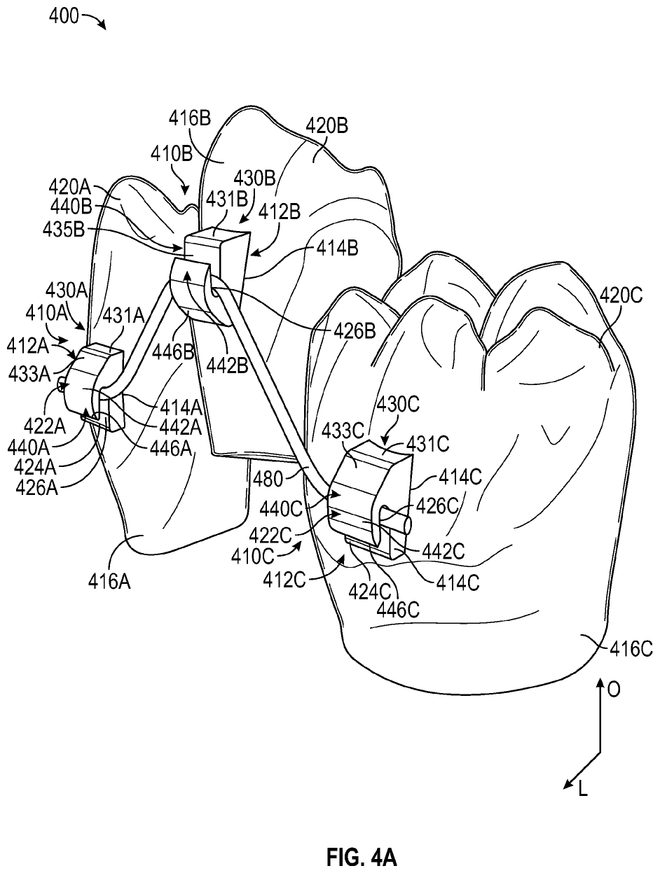

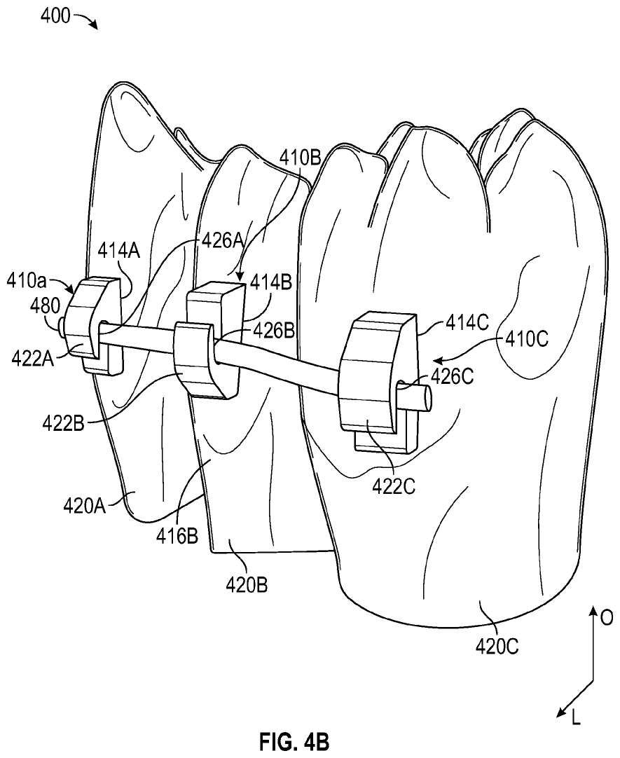

Referring now to FIG. 4A, an arrangement 400 of attachment articles 410A, 410B and 410C are shown that can be used to provide vertical (along the occlusal axis O) tooth movements in a mouth of a patient. In the arrangement 400, the attachment article 410A is bonded to a surface 416A of a first tooth 420A, and the attachment article 410C is bonded to a surface 416C of a third tooth 420C. The attachment article 410B is bonded to a surface 416B of a second tooth 420B between the teeth 420A and 420C. The second tooth 420B extends above a plane including the teeth 420A, 420C.

The attachment articles 410A, 410C include bodies 412A, 412C each having a bonding portion 414A, 414C attached to respective tooth surfaces 416A, 416C. The bodies 412A, 412C further include a spacer portion 430A, 430C that extend away from the tooth surfaces 416A, 416C. The spacer portions 430A, 430C include a substantially planar portion 431A, 431C that is substantially normal to the tooth surfaces 416A, 416C. The planar portions 431A, 431C extend into a downwardly facing catch 422A, 422C. The catches 422A, 422C each include an internal surface 424A, 424C that forms a generally J-shaped groove 426A, 426C configured to retain an archwire 480.

An external surface of the catches 422A, 422C include an exposed external engagement surface 440A, 440C configured to releasably engage an appropriately shaped indentation in an aligner tray (not shown in FIG. 4A). The engagement surfaces 440A, 440C include a rounded shoulder 442A, 442C and an undercut region 446A, 446C, which each form a roof-like shape that can releasably engage an indentation in an aligner tray.

The attachment article 410B includes a body 412B with a bonding portion 414B attached to the tooth surface 416B. The body 412B further includes a spacer portion 430B that extends outwardly from the tooth surface 416B. The spacer portion 430B includes a substantially planar portion 431B substantially normal to the tooth surface 416B. A wall 435B extends generally normal to the planar portion 431B and substantially parallel to the tooth surface 416B. The wall 435B forms an upwardly facing catch 422B. The catch 422B forms a generally J-shaped groove 426B configured to retain the archwire 480.

An external surface of the catch 422B includes an exposed external engagement surface 440B configured to releasably engage an appropriately shaped indentation in an aligner tray (not shown in FIG. 4A). The engagement surface 440B includes a rounded shoulder 442B and an undercut region 446B, which form a roof-like shape that can releasably engage an indentation in an aligner tray.

As shown schematically in FIG. 4B, the upwardly facing catches 422A, 422C retain the archwire 480, which exerts force against the groove 426B of the downwardly facing catch 422B in a direction generally parallel to the tooth surface 416B (occlusal direction). The constant downward force exerted against the groove 426B by the elastic archwire 480 gradually moves the tooth 420B vertically downward into alignment with the adjacent teeth 420A, 420C. As the tooth 420B moves downward, the grooves 426A, 426C in the catches 422A, 422C retain the archwire 480 in proper relation to the surfaces of the teeth 416A-C, and the malpositioned tooth is used to retain the archwire 480.

In some embodiments, the center attachment 410B can optionally be positioned higher on the surface 416B as an over-correction to ensure better engagement of the archwire 480 in the groove 426B of the catch 422B, and to maintain archwire retention even when the tooth 420B is in the intended position. In some examples, the attachment 410B can be positioned such that the forces applied to the tooth 420B fall below a threshold necessary to further move the tooth, and the attachment 410B retains the archwire.

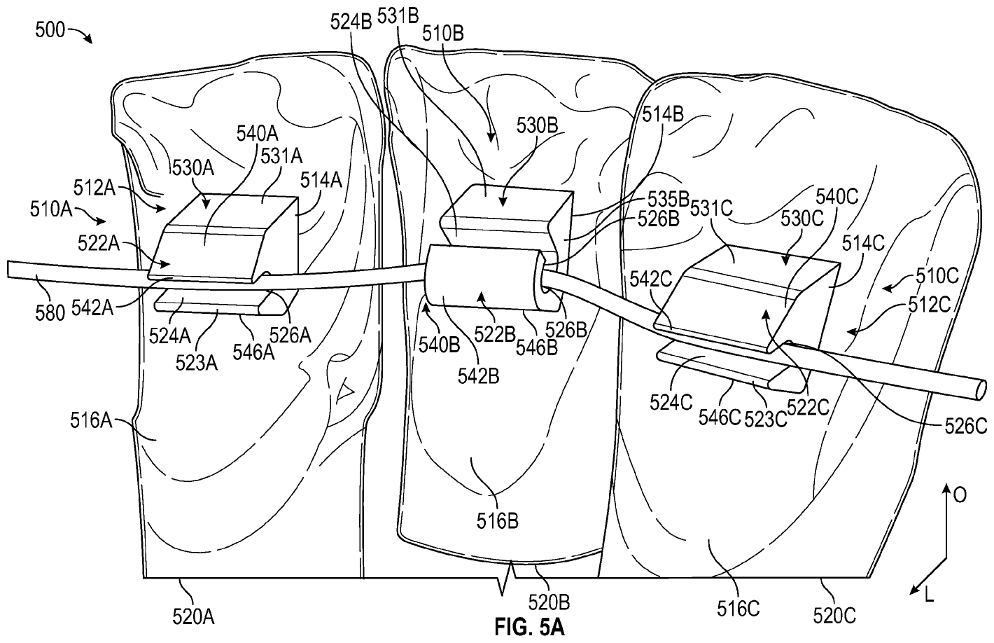

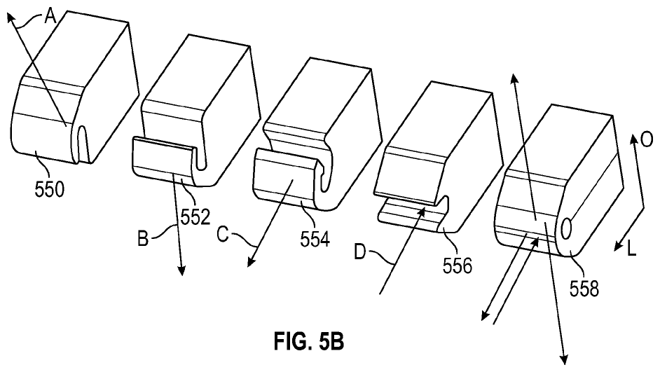

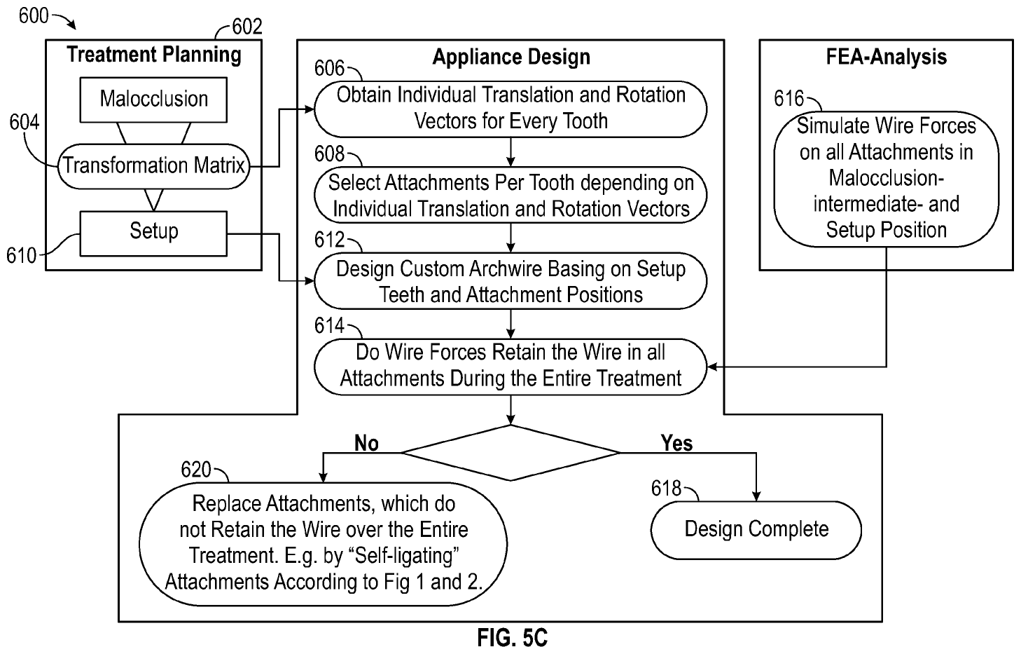

Referring now to FIG. 5A, in another embodiment an arrangement 500 of attachment articles 510A, 510B and 510C are shown that can have shapes and groove constructions suitable for moving a tooth along a horizontal (along the lingual axis L) direction in a mouth of a patient. In the arrangement 500, the attachment article 510A is bonded to a surface 516A of a first tooth 520A, and the attachment article 510C is bonded to a surface 516C of a third tooth 520C. The attachment article 510B is bonded to a surface 516B of a second tooth 520B between the teeth 520A and 520C. The second tooth 520B generally extends behind a plane including the teeth 520A, 520C.

The attachment articles 510A, 510C include bodies 512A, 512C each having a bonding portion 514A, 514C attached to respective tooth surfaces 516A, 516C. The bodies 512A, 512C further include a spacer portion 530A, 530C that extend outwardly from the tooth surfaces 516A, 516C. The spacer portions 530A, 530C include a substantially planar portion 531A, 531C that is substantially normal to the tooth surfaces 516A, 516C. The planar portions 531A, 531C extend into a downwardly facing catch 522A, 522C. The bodies 512A, 512C further include a generally upwardly facing catch 523A, 523C.

The upwardly facing catches 522A, 522C and the downwardly facing catches 523A, 523C form an internal surface 524A, 524C that forms a generally C-shaped groove 526A, 526C configured to retain an archwire 580.

An external surface of the catches 522A, 522C, 523A, 523C include an exposed external engagement surface 540A, 540C configured to releasably engage an appropriately shaped indentation construction in an aligner tray (not shown in FIG. 4A). The engagement surfaces 540A, 540C include a rounded shoulder 542A, 542C and an undercut region 546A, 546C.

The attachment article 510B includes a body 512B with a bonding portion 514B attached to the tooth surface 516B of a tooth 520B. The body 512B further includes a spacer portion 530B that extends outwardly from the tooth surface 516B. The spacer portion 530B includes a substantially planar portion 531B substantially normal to the tooth surface 516B. A wall 535B extends generally normal to the planar portion 531B and substantially parallel to the tooth surface 516B. The wall 535B forms a surface 524B that extends into an upwardly facing catch 522B. The catch 522B forms a generally J-shaped groove 526B configured to retain the archwire 580 and exert force along the lingual direction on the tooth 520B.

An external surface of the catch 522B includes an exposed external engagement surface 540B configured to releasably engage an appropriately shaped indentation construction in an aligner tray (not shown in FIG. 5A). The engagement surface 540B includes a rounded shoulder 542B and an undercut region 546B.

The groove J-shaped 526B in the catch 522B grabs the wire 580 like a hand grabs the handle of a bucket. The grooves 526A, 526C of the attachments 510A, 510C distal and mesial to the center attachment 510B point lingually, and the wire 580 is retained in the grooves 526A-C because of forces applied to the archwire 580 in a direction opposite to the groove openings.

FIG. 5B shows some examples of a variety of different attachment designs and the principal force Vectors they can apply to a tooth. For example, an attachment design 550 is configured to extrude/lengthen teeth along an occlusal direction A. An attachment 552 is flipped with respect to attachment 550, and as such intrudes teeth along the occlusal direction B opposite to occlusal direction A. An attachment design 554 includes a pronounced catch that is capable of moving a tooth along a lingual direction C (or in a direction opposite to C if bonded on a labial side of a tooth). The attachment 556 includes a slot through which a wire can apply force to move a tooth in a labial direction D. A tube-like catch design 558 could be used, for example, to retain a wire in teeth distal the tooth or teeth being moved by the archwire. Depending on the malocclusion and inter-attachment distance, in some embodiments a plurality of consecutive attachments 558 can be used to a retain a super elastic round archwire such as, for example, a 0.014 round NiTi.

In various embodiments, the attachments 550-558 can be selected manually or with software following an assessment of how a particular tooth needs to move from a first maloccluded position to a second less maloccluded position. In a digital setup software used to plan orthodontic treatments, the transformation matrix from malocclusion to setup is known for every tooth. From this matrix a resulting movement vector can be defined. Based on these data, software could select from the above attachments that best represents the movement vector. For example, if primarily lingual tooth movement is desired, software could initially select the attachment 554 in FIG. 5B. In some examples, software can also be used to simulate the wire deflection and incorporate the result into an attachment selection.

When software is utilized to determine the precise movement for each tooth, in some embodiments the attachments of FIG. 5B can also be fine-tuned by turning them with certain limits around the wire axis.

Referring now to FIG. 5C, a process 600 includes a treatment planning step 602 in which a selection of attachments (including, but not limited to, the attachments 550-558 shown in FIG. and archwires is selected for use in a wire-driven phase of an orthodontic treatment plan to at least partially resolve one or more patient malocclusions. The treatment planning step 602 includes a step 604 of forming a transformation matrix. A first portion of the transformation matrix is created in an appliance design phase 606 in which individual translation and rotation vectors are obtained for each tooth to be orthodontically treated, followed by a second portion in which appropriate attachments are selected in step 608 for each tooth depending on the individual translation and rotation vectors from step 606.

In a setup phase 610, one or more custom archwires are configured in an appliance design phase 612 based on the tooth attachment positions and selected attachments determined in steps 606 and 608. In step 614, the design is examined using finite element analysis (FEA) in step 616 to determine if the wire forces retain the archwires in all attachments during the entire course of patient treatment.

If FEA determines that the wire forces will retain the archwires in the selected attachments, the design is completed in step 618. If one or more of the archwires may potentially be dislodged from an attachment during treatment, in step 620 the attachments may optionally be replaced with a self-ligating attachment design (see, for example, FIGS. 1-2) with a catch and grooves configured to more securely retain the archwires.

Once the attachments and archwires are configured, and the locations of an attachment is determined for each tooth, the wire-driven phase of the orthodontic treatment commences.

The process of FIG. 5C is not intended to be limiting and is merely provided as an example of how relatively simple, low-cost attachments such as those shown in FIG. 5B can be combined with a selected archwire to complete a wide variety of orthodontic treatments.

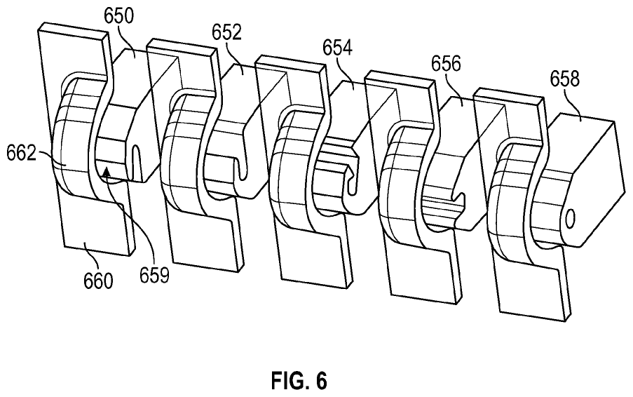

As shown schematically in FIG. 6, although all the attachments 650-658 reproduced from FIG. 5B have different wire retaining groove configurations and are configured to exert forces in different directions on a tooth, the attachments have one common basic external roof-like geometry, which provides a substantially similar or uniform attachment surface 659 for releasable engagement with an indentation 662 in an aligner tray 660. The common attachment surfaces 659 allow the attachments 650-658 to be used for the aligner phase of the orthodontic treatment method above independent from their individual geometry and groove shape. The shape of the indentations 662 in the aligner tray 660 can all be made the same, although a plurality of different attachments can be used to move teeth along different directions in a mouth of a patient.

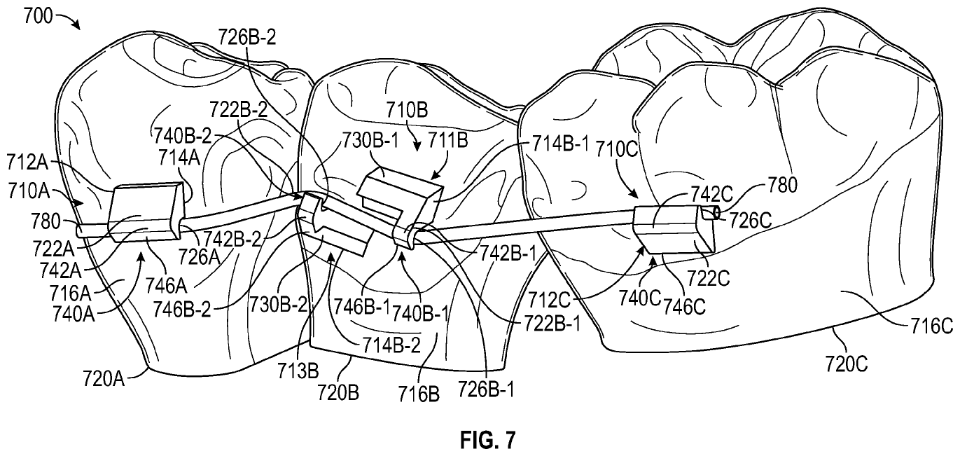

Referring now to FIG. 7, an arrangement of attachments 700 configured to resolve tooth angulation includes an attachment article 710A including a body 712A with a bonding portion 714A attached to a surface 716A of a tooth 720A. The body 712A includes a downwardly (i.e., gingivally) facing catch 722A that forms a wire-retaining groove 726A configured to retain an archwire 780 adjacent to the surface 716A of the tooth 720A. An external surface of the catch 722A includes an exposed external engagement surface 740A configured to releasably engage an appropriately shaped indentation construction in an aligner tray (not shown in FIG. 7). The engagement surface 740A includes a rounded shoulder 742A and an undercut region 746A.

Similarly, an attachment article 710C includes a body 712C with a bonding portion 714C attached to a surface 716C of a tooth 720C. The body 712C includes an upwardly (i.e., occlusally) facing catch 722C that forms a wire-retaining groove 726C configured to retain the archwire 780 adjacent to the tooth surface 716C. An external surface of the catch 722C includes an exposed external engagement surface 740C configured to releasably engage an appropriately shaped indentation construction in an aligner tray (not shown in FIG. 7). The engagement surface 740C includes a rounded shoulder 742C and an undercut region 746C.

A tooth 720B includes an attachment article 710B with a first body 711B and a second body 713B. The bodies 711B and 713B each attach to a tooth surface 716B via respective bonding portions 714B-1 and 714B-2.

The first body 711B includes a spacer portion 730B-1 extending outwardly from the tooth surface 716B, and a downwardly facing catch 722B-1 extends along a portion of a length of the spacer portion 730B-1. The catch 722B-1 forms a generally J-shaped groove 726B-1 configured to retain the archwire 780 adjacent to the tooth surface 716B. An external surface of the catch 722B-1 includes an exposed external engagement surface 740B-1 configured to releasably engage an appropriately shaped indentation in an aligner tray (not shown in FIG. 7). The engagement surface 740B-1 includes a rounded shoulder 742B-1 and an undercut region 746B-1.

Similarly, the second body 713B includes a spacer portion 730B-2 extending outwardly from the tooth surface 716B but has an upwardly facing catch 722B-2 that extends along a portion of a length of the spacer portion 730B-2. The upwardly facing catch 722B-2 works along with downwardly facing catch 722B-1 on the first body 711B to securely retain the archwire 780 and angulate the tooth 720B. The catch 722B-2 forms a generally J-shaped groove 726B-2 configured to retain the archwire 780 adjacent to the tooth surface 716B. In the embodiment of FIG. 7, the groove 726B-2 and the groove 726B-1 can have very similar cross-sectional shapes, but in other examples may have different shapes, depending on the intended application.

An external surface of the catch 722B-2 includes an exposed external engagement surface 740B-2 configured to releasably engage an appropriately shaped indentation construction in an aligner tray (not shown in FIG. 7). The engagement surface 740B-2 includes a rounded shoulder 742B-2 and an undercut region 746B-2.

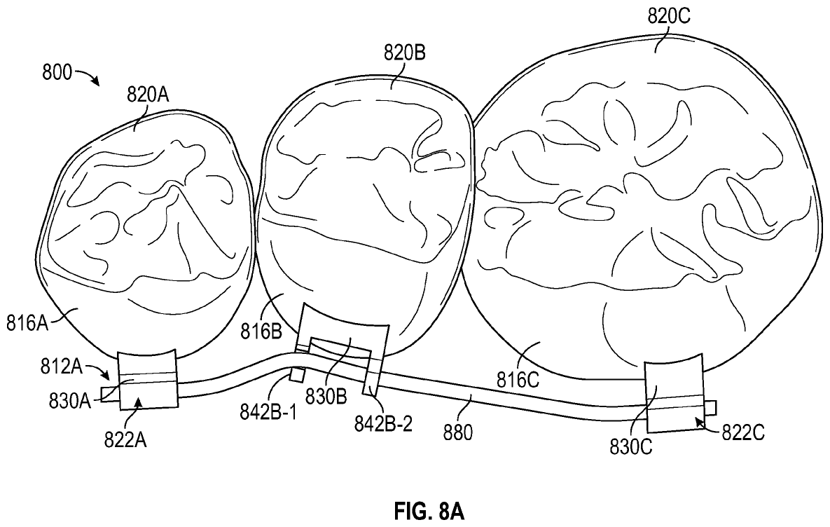

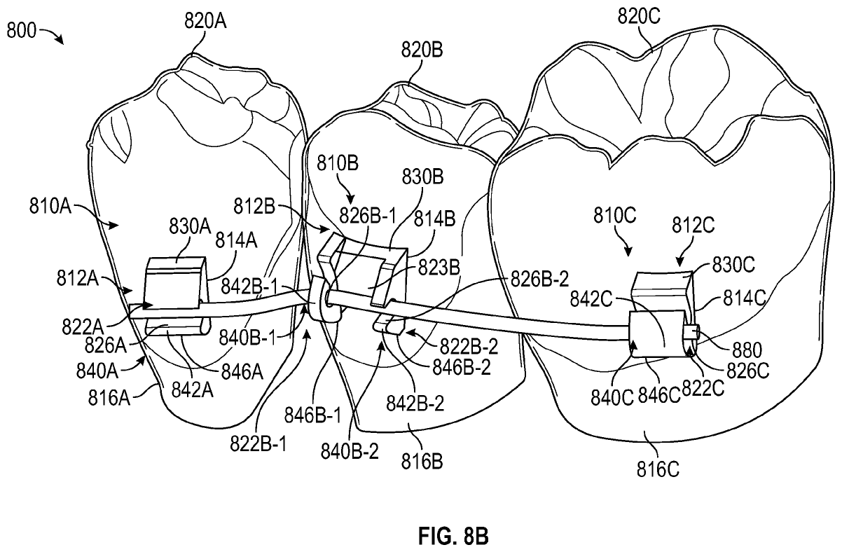

Referring to FIGS. 8A-8B, if a tooth needs a rotation correction, an arrangement 800 of attachments can be used to apply horizontal forces suitable to create the necessary moment for rotation. The teeth mesial and distal of the tooth to be rotated also feature attachments for horizontal tooth movements to cope with the counterforces. As shown in FIGS. 8A-8B, teeth 820A, 820B, 820C include respective attachment articles 810A, 810B, 810C with bodies 812A, 812B, 812C affixed to tooth surfaces 816A, 816B, 816C via bonding portions 814A, 814B, 814C.

The body 812A of the attachment article 810A includes a spacer 830A which forms a downwardly facing catch 822A. The body 812A further forms a groove 826A with a generally C-shaped cross section configured to retain an archwire 880. The catch 822A includes an exposed external engagement surface 840A configured to releasably engage an appropriately shaped indentation in an aligner tray (not shown in FIGS. 8A-B). The engagement surface 840A includes a rounded shoulder 842A and an undercut region 846A.

The body 812C of the attachment article 810C includes a spacer 830C that extends normal to the tooth surface 816C. The body 812C forms an upwardly facing catch 822C with a groove 826C having a J-shaped cross section configured to retain the archwire 880. The catch 822C includes an exposed external engagement surface 840C configured to releasably engage an appropriately shaped indentation construction in an aligner tray (not shown in FIG. 8). The engagement surface 840C includes a rounded shoulder 842C and an undercut region 846C.

The body 812B of the attachment article 810B includes a spacer 830B that extends normal to the tooth surface 816B. The body 812B forms a first upwardly facing catch 822B-1 with a groove 826B-1 having a J-shaped cross section configured to retain the archwire 880. The body 812B further includes a second downwardly facing catch 822B-2 with a C-shaped cross section and a groove 826B-2. The catches 822B-1 and 822B-2 are separated by a medial portion 823B of the body 812B that is oriented generally parallel to the tooth surface 816B.

The catches 822B-1 and 822B-2 each include an exposed external engagement surface 840B-1 and 840B-2 configured to releasably engage an appropriately shaped indentation construction in an aligner tray (not shown in FIG. 8). The engagement surfaces 840B-1 and 840B-2 each include a respective rounded shoulder 842B-1 and 842B-2 and an undercut region 846B-1 and 846B-2.

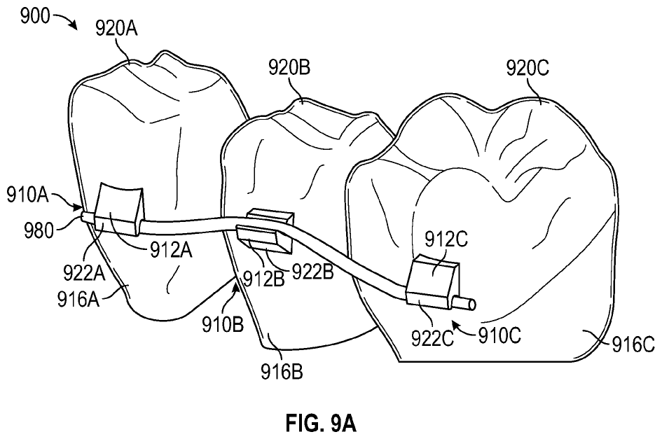

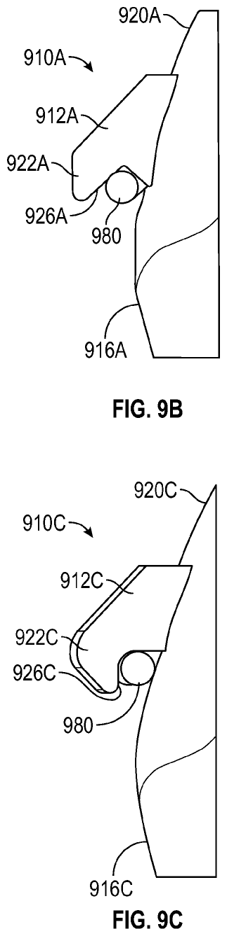

As shown in FIGS. 9A-9C, in some embodiments the wire-retaining grooves in the attachments can be configured to allow the archwire to reside a predetermined distance from a surface of the tooth. In the system 900, a tooth 920A includes an attachment 910A with a body 912A bonded to a surface 916A. The body 912A includes a downwardly facing catch 922A having a wire-retaining groove 926A configured to retain an archwire 980. Similarly, a tooth 920B includes an attachment 910B bonded to a surface 916B thereof. The attachment 910B includes a body 912B having an upwardly facing catch 922B with a wire-retaining groove 926B. An attachment 910C is bonded to a surface 916C of a tooth 920C, and features a body 912C having a downwardly facing catch 922C with a wire-retaining groove 926C.

As shown in FIGS. 9B-9C, the groove 926A in the attachment 910A has a generally V-shaped cross-section, and the archwire 980 abuts the body 912A of the attachment 910A. In contrast, the groove 926C in the attachment 910C has a generally J-shaped cross-section, and retains the archwire 980 in direct abutment against the tooth surface 916C. As shown in FIG. 910C, in some embodiments of the attachments of the present disclosure the tooth surface itself replaces one or more surfaces of the attachments, thus creating an inside corner, or a slot, in which the archwire is seated when forces are directed toward the interior. By surrounding the archwire on 2 or more sides, wherein the resultant force exerted by the archwire is directed along a plane that is oriented somewhere between at least 2 planes of the interior sides of the inside corner or slot, the net effect is that the archwire is channeled into the slot and thereby prevented from popping out. As such, forces are reliably transmitted from the archwire through the attachment and to the tooth.

In some embodiments, relatively simple attachments designs such as those shown in FIGS. 9A-9C could even provide a dental practitioner an opportunity to mold the attachments chairside from suitable composite material.

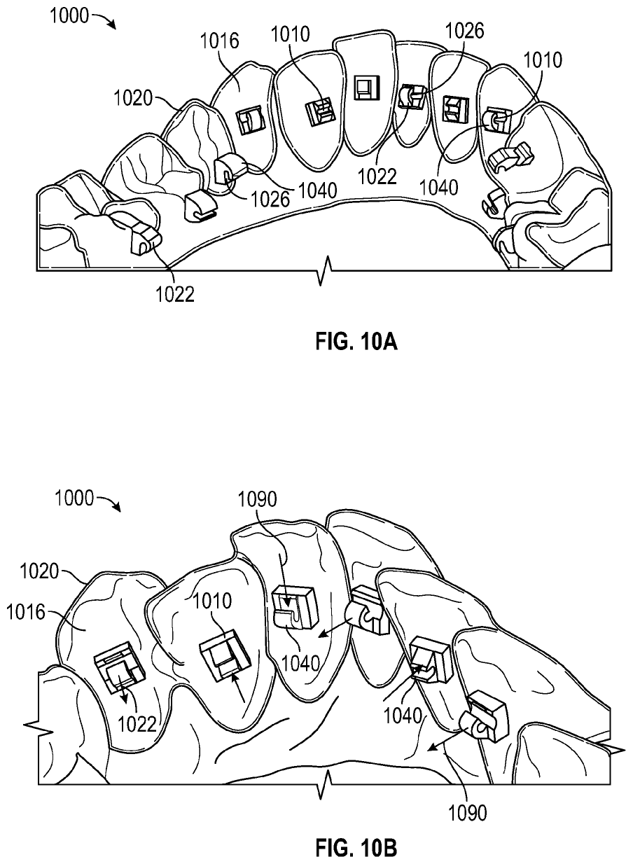

FIGS. 10A-10B schematically represent an orthodontic system 1000 including an arrangement of attachments 1010 attached to lingual surfaces 1016 of teeth 1020. Each of the attachments 1010 includes a catch 1022 and a wire-retaining groove 1026 selected to utilize an archwire (not shown in FIGS. 10A-10B) to move teeth according to a wire-driven phase of a predetermined patient treatment plan. As shown in FIG. 10B, the catch designs 1022 of the attachments 1010 provide individual force vectors 1090 selected for a desired tooth movement in the wire-driven treatment phase. While the shape of the catches 1022 varies depending on the desired force vector to be applied on a tooth, each of the attachments 1010 includes a substantially similar engagement surface 1040 configured to releasably engage a corresponding indentation in an aligner tray (not shown in FIGS. 10A-10B).

Following the completion of the wire-driven phase of the treatment plan, the archwire is removed from the attachments 1010, and the attachments remain in position on the teeth. The engagement surfaces 1040 on the attachments 1010 can be used to releasably connect to the aligner tray during an aligner phase of treatment that follows the wire-driven treatment phase.

Various embodiments of the invention have been described. These and other embodiments are within the scope of the following claims.

1. A method for repositioning a first maloccluded tooth of a patient, the method comprising:
a wire driven phase, comprising:
providing a plurality of attachments, each attachment comprising a wire-retaining region and an engagement region, wherein the engagement region comprises a shoulder configured to releasably engage a corresponding indentation in an aligner tray;
bonding each attachment in the plurality of attachments to a tooth of the patient;
inserting an archwire in to the wire-retaining regions in the attachments to move the first maloccluded tooth from a first position to a second position different from the first position; and
an aligner phase following the wire driven phase, the aligner phase comprising:
removing the archwire from the wire-retaining regions in the plurality of attachments, and
applying an aligner tray over the teeth of the patient, wherein the aligner tray comprises a plurality of cavities shaped to receive and resiliently position the first maloccluded tooth from the second position to a third position different from the second position, the aligner tray further comprising an arrangement of indentations configured to releasably engage at least a portion of the engagement regions on the attachments.

2. The method of claim 1, further comprising a second wire-driven phase following the aligner phase.

3. The method of claim 1, wherein the attachments comprise a body, the body comprising:
a bonding portion configured for bonding a surface of a tooth;
a spacer extending away from the bonding portion, and
a catch comprising an internal surface, wherein the internal surface comprises the wire-retaining groove.

4. The method of claim 3, wherein the internal surface of the wire-retaining groove comprises a shape configured to retain an archwire against the body of the attachment or between the body of the device and the surface of the tooth.

5. The method of claim 3, wherein the catch further comprises a retaining region overlying at least a portion of the wire-retaining groove.

6. The method of claim 3, wherein the spacer has a first surface and a second surface, and wherein the bonding portion resides in a region between the first surface and the second surface of the spacer.

7. The method of claim 3, wherein the spacer has a first surface and a second surface, and wherein the bonding portion occupies a region that extends beyond either the first surface or the second surface of the spacer.

8. (canceled)

9. The method of claim 1, wherein the shoulder comprises a plurality of sloping segments.

10. The method of claim 1, wherein the shoulder comprises an arcuate shoulder portion and an undercut region.

11. The method of claim 1, wherein the indentation in the aligner tray is chosen from a protrusion, a bubble, an envelope, a slot, an aperture, an annulus, a wedge, a prism, and combinations thereof.

12. The method of claim 1, wherein at least some of the indentations in the aligner tray are configured to provide an insertion path to releasably receive at least one of the attachments.

13. The method of claim 1, wherein the indentations comprise a shortened wall extending less than an entire distance between an occlusal portion of the at least one tooth having an attachment thereon and a gingival line of the at least one tooth having the attachment thereon, [,] wherein the shortened shell wall extends partially over the at least one attachment when the tooth having the attachment thereon is received within the cavity.

14. An orthodontic treatment system, comprising:
a plurality of attachments, each attachment comprising a body with a first end comprising a bonding portion configured to be bonded to a surface of a tooth of a patient; and a second end opposite the first end, wherein the second end comprises a catch configured to retain an archwire, and wherein an external surface of the catch comprises an engagement region with a shoulder;
a plurality of archwires insertable into the wire retaining hooks in the attachments; and
at least one aligner tray, each aligner tray comprising a plurality of cavities shaped to receive and resiliently position at least one tooth of the patient, the aligner tray further comprising at least one indentation configured to releasably engage with the shoulder in the engagement region of at least one attachment in the plurality of attachments.

15. (canceled)

16. An attachment device for an orthodontic treatment, the device comprising: a body, comprising:
a first end comprising a bonding portion configured to be bonded to a surface of a tooth; and
a second end opposite the first end, wherein the second end comprises a wire-retaining groove and an external surface comprising an engagement region, wherein the engagement region comprises a shoulder configured to releasably engage a corresponding indentation in an aligner tray.

17. The attachment device of claim 16, wherein the internal surface of the wire-retaining groove comprises a shape configured to retain a wire against the body of the device.

18. The attachment device of claim 16, wherein the internal surface of the wire-retaining groove comprises a shape configured to retain a wire therein between the body of the device and the surface of the tooth.

19. The attachment device of claim 16, further comprising a retaining region overlying at least a portion of the wire-retaining groove.

20. The attachment device of claim 16, wherein the wire-retaining groove comprises one of a U-shaped cross-section configured to translate a force applied therein to a tooth-movement force in a direction substantially parallel to a plane of the bonding pad, and a J-shaped cross-section configured to translate a force applied therein to a tooth-movement force in a direction substantially normal to a plane of the bonding pad.

21. The attachment device of claim 16, wherein the body comprises:
a spacer extending away from the bonding pad,
a catch extending from the spacer in a first direction with respect to a plane of the spacer, wherein the catch comprises a wire-retaining groove with a C-shaped cross-section configured to translate a force applied therein to a tooth-movement force in a direction substantially normal to a plane of the bonding pad.

22. The attachment device of claim 16, wherein the body comprises:
a spacer extending away from the bonding pad,
a catch extending from the spacer in a first direction normal to a plane of the spacer, wherein the catch extends along a portion of a length of the spacer along a second direction normal to the first direction and parallel to the plane of the spacer, and wherein a cross-section of the wire-retaining groove is configured to translate a force applied therein to a tooth-movement force substantially parallel to a plane of the bonding pad.

23. (canceled)
